(19) United States
(12) Patent Application Publication
(10) Pub. No.: US 2023/0382009 A1
(43) Pub. Date: Nov. 30, 2023

(54) INTERCONNECT SUPPORT PLUNGER FOR CONCRETE BLOCK FORMING SHOE

(71) Applicant: Columbia Machine, Inc., Vancouver, WA (US)

(72) Inventor: Josef Ott, Hagerstown, MD (US)

(21) Appl. No.: 17/827,892

(22) Filed: May 30, 2022

(51) Int. Cl. B28B 7/10; B28B 7/24

(52) U.S. Cl. CPC B28B 7/10; B28B 7/24

(57) ABSTRACT

In a head assembly for use on a concrete products forming machine (CPM), a framework is configured to be secured to a vertically displaceable compression beam on the CPM. An array of shoes are sized to be fully received within complimentary mold cavities within a mold box of the CPM. An array of plungers are interposed between the framework and array of shoes, with at least a plurality of the plungers of the array secured at one end to the framework and at another end to a single one of the array of shoes. The plurality of plungers are configured with a C-shaped webbing comprised of upper and lower substantially parallel flange pieces connected via a structural upright forming an outside right-angle edge with each of the upper and lower flange pieces.

### BACKGROUND OF THE INVENTION

### 1. Field of the Invention

The present invention relates to machines for forming concrete products and, more particularly, to methods and apparatuses for structurally suspending extrusion shoes within the head assemblies of such machines.

### 2. Description of the Prior Art

Concrete products forming machines (CPMs), use molds having multiple cavities that are sized and shaped to yield the desired concrete product. Such molds are mounted within a CPM, its cavities filled with concrete, and the mold vibrated to remove air bubbles from the concrete within the cavities. A head assembly, having multiple punches or stamps (also referred to as “shoes”) on its lower end that are arranged to align with the mold cavities, then lowers so that the shoes enter the cavities and push out the molded concrete products out the bottom end of the mold. The molded products are then cured and ready for use.

Concrete block molding machines run continuously under extreme conditions of use during stone production and are only stopped for retrofitting work or for repairs. During the production of concrete blocks, large forces act on the individual parts of the upper mold part of the concrete block molding machine and therefore lead to considerable wear, in particular the shoes.

In known upper mold parts for concrete block molding machines, the lower parts with the shoes are fastened to a base plate or a head plate of the upper part by means of a stamp profile or a pressure transmission means. The pressure transmission means are conventionally welded to the head plate and only the lower parts with the stamps are interchangeably attached to the stamp profiles or to the pressure transmission means. Shoe profiles welded to the head plate in this way are very robust against the effects of force during operation of the concrete block molding machine and therefore offer high stability. However, the possible uses of the respective upper mold parts are limited, since only certain lower parts with certain dimensions with stamps fit on the permanently welded shoe profiles. Thus, concrete blocks with only certain sizes and shapes can be formed with a certain upper part of the mold.

If it is desired to convert the top part of the concrete block molding machine from producing larger to smaller concrete blocks, or vice versa, it must be ensured that the pressure transmission means do not cut or touch the mold walls of the mold frame during operation. The shoe profiles must be attached to the head plate in such a way that the shoe profiles do not protrude beyond the area of the shoe and cannot come into contact with the mold walls of the mold frame. An impact of a pressure transmission medium on the mold frame could lead to considerable damage to the mold frame and the pressure transmission medium due to large forces during operation, and even the failure of the entire concrete block molding machine.

Great care must therefore be taken when positioning the pressure transmission means during the welding process in order to ensure that the shoe profiles are arranged precisely. Even the smallest deviations in the position of a shoe can cause damage in a mold cavity of a mold frame. Repair work is often very cost-intensive and often leads to long downtimes during which the concrete block molding machine cannot be put into operation. In extreme cases, an incorrect welding of the pressure transmission means to the head plate is irreparable and the entire head plate with the welded pressure transmission means becomes unusable. In the worst case, the concrete block molding machine can be completely destroyed if an incorrectly welded pressure transmission medium is not noticed in time and the concrete block molding machine is nevertheless put into operation.

In the case of welded-on pressure transmission means, only shoes can be attached which are specifically aligned with these pressure transmission means. It may well be possible, for example, that very large shoes can be attached to a pressure transmission means designed for smaller shoes. However, even, symmetrical power transmission is not necessarily guaranteed. An uneven pressure force transmission of the pressure transmission means to the lower parts and thus to the shoe inevitably leads to poor molding results and to rapid and asymmetrical wear of the shoe, the pressure transmission means, and the mold walls of the mold frame.

In addition, repair of the upper mold part is very cumbersome and time-consuming since, in the case of a damaged pressure transmission medium for example, the entire upper mold part must be removed from the concrete block molding machine in order to be able to replace the damaged pressure transmission medium. Since the pressure transmission medium is welded to the head plate, it must be separated from the head plate by sawing or torch cutting, so that a new shoe profile can then be welded on again. Not only is this very time consuming, it also requires trained personnel and special tools such as grinding saws and oxy-acetylene torches. Any such repairs can cause a long downtime of the concrete block molding machine, with a considerable production loss.

Additional problems arise in that the pressure transmission means between the head assembly structure and the shoe can cause additional stress on any connecting hardware or undue torquing. This torquing can result in the sides of the shoe impacting upon the interior sidewalls of the mold cavities thus potentially damaging both the molds and the shoes, which can lead to a reduction in the lifespan of the parts used and additional CPM downtime during the production process.

Accordingly, the need arises for an improved pressure transmission means between the head assembly structure of a concrete products forming machine (CPM) and easily replaceable extrusion shoes that overcomes the drawbacks of the prior art.

### SUMMARY OF THE INVENTION

One aspect of the invention comprises a plunger for use between a shoe and framework in a concrete products forming machine. The plunger comprises a C-shaped webbing comprised of upper and lower substantially parallel flange pieces connected via a structural upright forming an outside right-angle corner with each of the upper and lower flange pieces. In a preferred embodiment, the plunger further includes an inside-angle edge between the upper and lower flange pieces and the interposed structural upright defined by a first radius.

Another aspect of the invention comprises a head assembly for use on a concrete products forming machine (CPM) that incorporates these plungers. The head assembly includes a framework configured to be secured to a vertically displaceable compression beam on the CPM and an array of shoes sized to be fully received within complimentary mold cavities within a mold box of the CPM. An array of inventive plungers are interposed between the framework and array of shoes, with at least a plurality of the plungers of the array secured at one end to the framework and at another end to a single one of the array of shoes. The plurality of plungers are configured with a C-shaped webbing comprised of upper and lower substantially parallel flange pieces connected via a structural upright forming an outside right-angle edge with each of the upper and lower flange pieces.

The invention relates to an upper mold part for fastening to a concrete block molding machine, comprising: a head plate, a lower part which includes at least one punch, at least one pressure transmission means which the head plate connects to the lower part, and wherein the at least one pressure transmission means further comprises at least one central web, at least one upper fastening section, and at least one lower fastening section. The upper fastening section and the lower fastening section are each formed essentially at right angles to the central web. The lower fastening section is non-positively connected to the lower part but the upper fastening section is positively connected to the head plate.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view showing the head assembly of a concrete products machine (CPM) that includes plungers implemented according to teachings of the invention.

FIG. 2 is a magnified exploded view of FIG. 1 showing a portion of the head assembly and attachment of the inventive plungers between the head assembly framework and an associated shoe.

FIG. 3 is side elevation sectional view of the portion of the head assembly shown in FIG. 2.

FIG. 4 is a side view in partial section of a plunger implemented according to teachings of the invention.

### DETAILED DESCRIPTION

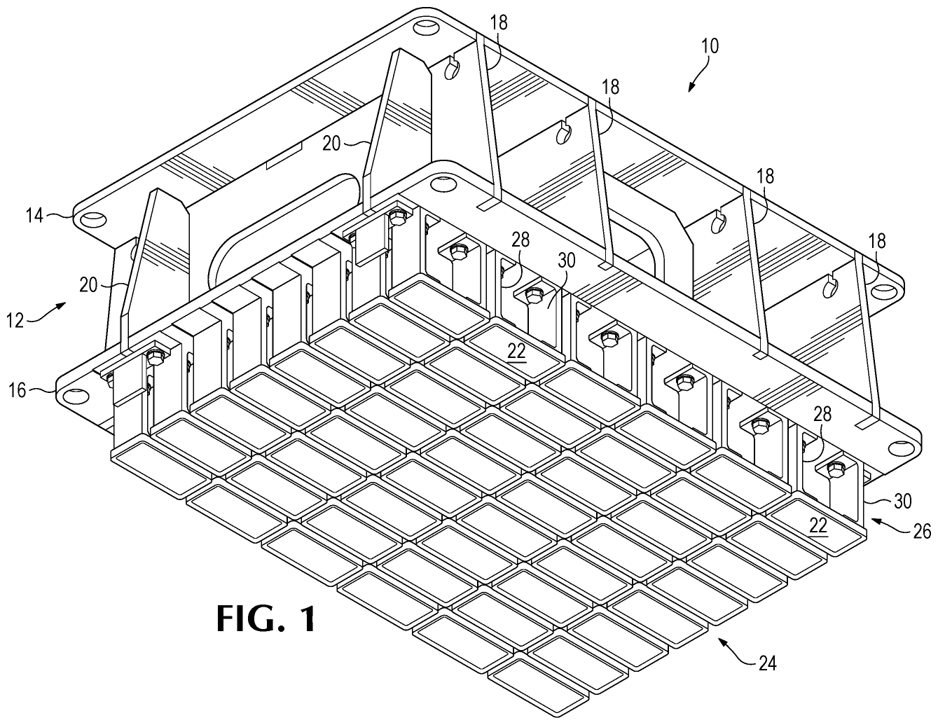

FIG. 1 illustrates a head assembly 10 of a concrete products forming machine (CPM) as configured according to an aspect of the invention. Head assembly 10 includes a structural framework 12 comprised of an upper head plate 14 and vertically spaced lower base plate 16 coupled together via a structural webbing of cross support members 18 and struts 20. The framework 12, and particularly the head plate 14, is configured to be secured to a vertically displaceable compression beam on the CPM (not shown) so that the shoes 22 (described in more detail below) coupled at the lower end of the head assembly 10 are moved downward into, and extrude compressed concrete from, complementary mold cavities to form the molded products.

Head assembly 10 includes an array 24 of shoes 22 that are sized to be fully received within complimentary mold cavities within a mold box of the CPM. FIG. 1 illustrates an 6×8 array of shoes that result in formation of 48 molded products during a single compression cycle of the head assembly 10. An array 26 of pressure transmission means (interconnect support clamps or plungers 28, 30) are interposed between the framework 12 and array 24 of shoes 22. In a preferred implementation of the head assembly 10, at least a plurality of the plungers of the array 26 are secured at one end to the framework 12 and at another end to a single one of the array of shoes. As shown in FIG. 1 paired plungers 28, 30 are coupled between the base plate 16 on an upper end and shoe 22 on a lower end.

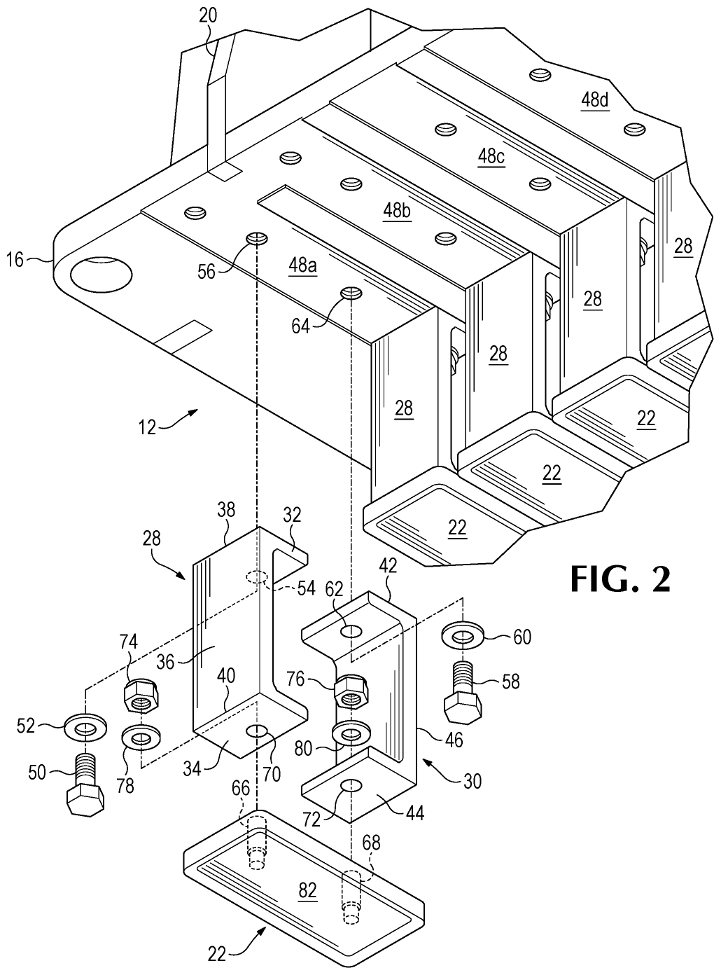

FIG. 2 shows a magnified view of a corner portion of the head assembly 10 of FIG. 1 with several plunger and shoe assemblies removed from the base plate 16 to show attachment points beneath. Each of the plurality of plungers, plunger 28, is configured with a C-shaped webbing comprised of upper and lower substantially parallel flange pieces—flange pieces 32 and 34, respectively—connected via a structural upright 36 that forms an outside right-angle edge—e.g. edges 38 and 40, respectively—with each of the upper 32 and lower 34 flange pieces.

In a preferred embodiment, each of the shoes 22 in the array 24 include a plurality of associated plungers coupled thereto that are spaced from one another. As shown in FIG. 2, the plurality of associated plungers for each of the shoes includes a pair of plungers 28, 30 coupled in spaced relation to one another such that the C-shaped webbing of each of the plungers in the pair face inwards toward one another with the structural upright 36 of each plunger on the outside. That is, the upper flange pieces 32, 42 of the paired plungers 28, 30 do not touch one another and the lower flange pieces 34, 44 are similarly spaced apart. The structural uprights 36, 46 of plungers 28, 30 are preferably thicker than the flange pieces 32, 34, 42, 44.

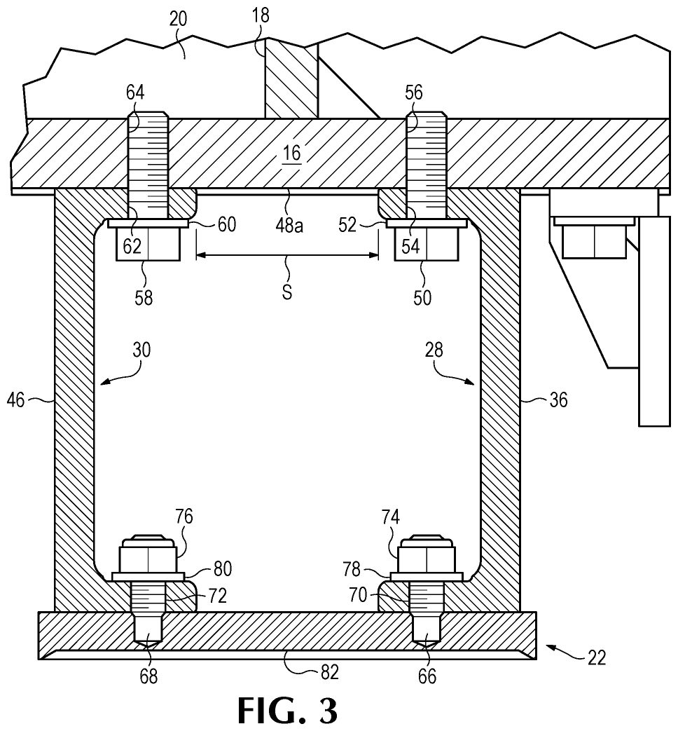

The framework 12 includes a plurality of grooves 48a, 48b, 48c, 48d disposed in parallel on an underside of base plate 16, with the array of plungers received within the grooves to mitigate twisting of the plungers with respect to the framework. These grooves 48a are approximately 2 mm deep and are machined to keep the plungers 28, 30 from rotating once affixed within the groove. As shown also in FIG. 3, plunger 28 is coupled to the base plate 16 and retained within the groove 48a as via a bolt 50 and washer 52 received through an aperture 54 formed through the upper flange piece 32 and threaded into a threaded aperture 56 within base plate 16. Similarly, plunger 30 is coupled in spaced relation to plunger 28 within groove 48a via similar means, e.g. bolt 58 and washer 60 received through an aperture 62 formed through the upper flange piece 42 and threaded into another threaded aperture 64 within base plate 16. Spacing S between the inwardly-facing, proximal ends of the upper flange pieces 32, 42 is between about three to four inches and is structured so that the structural upright elements 36, 46 of respective plunger pairs 28, 30 approximately align just inward of the outer expanse of shoe 22. The number of plungers used for a square foot area of shoes is between about six and ten.

Each of the shoes 22 include a pair of threaded pins 66, 68 affixed to a top (non-stamping) side thereof that are received within respective apertures 70, 72 formed through the lower flange pieces 34, 44 of plungers 28, 30. The single shoe 22 is coupled to the pair of flanges 28, 30 using nuts 74, 76 and washers 78, 80 threaded onto the ends of the respective pins 66, 68. Sperrkant washers are desired to secure the lock nut and securely maintain the shoe to the plungers.

The shoe 22 shown in FIG. 3 is representative of a type having a profiled stamping surface 82 intended to mold a chamfered edge onto the top surface of the molded concrete product. However, other profiles are possible such as having an embossed chamfered section, dimples for vision impaired paver, standard 6 mm 30° chamfer, or an embossed surface and chamfer that mimics natural stone.

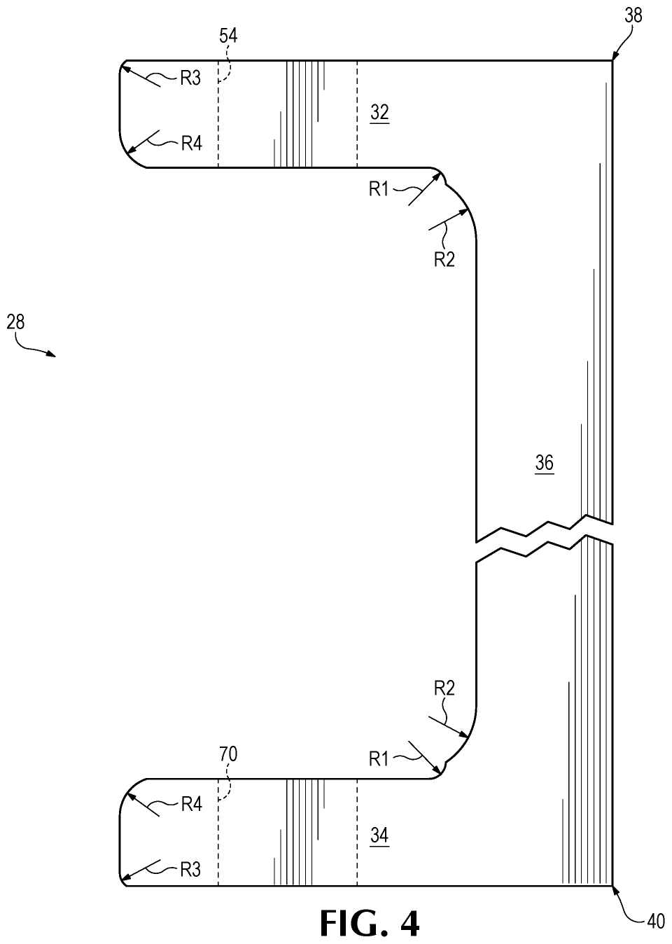

FIG. 4 shows a single plunger 28 implemented according to a preferred embodiment of the invention and includes a C-shaped webbing comprised of upper and lower substantially parallel flange pieces 32, 34 connected via a structural upright 36 forming an outside right-angle corner 38, with each of the upper and lower flange pieces 32, 34. Right-angle corners 38, 40 allow the upper flange piece 32 to make full contact along its length with, and be fully supported by, the framework base plate 16 on a first side, and the lower flange piece 34 to make full contact along its length with the underside of shoe 22. In this fashion, any force created by the shoe pressing the wet concrete out the mold cavity is translated along the structural upright 36 of the plunger 28 (and plunger 30) and minimizes any moment around the connecting elements—e.g. bolts 50, 58 and pins 66, 68—that could otherwise cause the C-shaped plungers 28, 30 to twist and pancake. The structural upright 36 of plunger 28 is preferably thicker than the flange pieces, being around 15 mm thick versus 10-12 mm thick for the flange pieces 32, 34, and has a hot rolled or forged profile that is machined to include several radiuses on proximal and distal portions of the flange pieces. Preferably, the plunger 28 is forged so that the grain direction of the steel forged element is structured to follow the direction of the upright 36 and the flanges 32, 34—a direction that is typically different than if the C-plunger shape is formed by rolling.

An inside-angle edge between the upper and lower flange pieces 32, 34 and the interposed structural upright is defined by one or more radii in order to prevent stress risers that would otherwise form on inside corners of the forged steel structure. A first radius R1 of approximately two millimeters or greater is preferably formed by machining. The plunger 28 can further include a second inside-angle edge radius R2 of approximately eight millimeters between the upper and lower flange pieces 32, 34 and the interposed structure upright 36 adjacent the first radius R1. Preferably, the first radius R1 is adjacent the flange pieces 32, 34 and the second radius R2, and the second radius R2 is adjacent the structural upright 36 and the first radius R1, and wherein the first radius R1 is smaller than the second radius R2. The second radius R2 is preferably formed in the forging process, and the first radius R1 is preferably formed via machining to ensure that the top of the flange is parallel to the bottom surface and to better shape the curve R2 into that top surface without creating an undue stress riser on that inside corner. The upper and lower flange pieces include first and second rolled edges on a distal section of the flange pieces 32, 34 of a third radius R3 of approximately three millimeters and a fourth radius R4 of approximately five millimeters, with R3 and R4 preferably being different from one another. The upper and lower flange pieces 32, 34 each include an aperture (apertures 54, 70, respectively) formed therethrough that are each configured to receive a fastener for fixing the plunger between the shoe and framework as described above. Finally, the aperture 54 on the upper flange 32 may be laterally offset relative to aperture 70 on the lower flange 34 so that fasteners receive within the apertures are parallel but not axial to one another.

With the plunger so configured, the force which is being translated from the shoe 22 to the head assembly framework 12 via the C-Style plunger 28 is in line with the main body 36, thus mitigating any undue torquing. This in contrast to plungers having rolled/rounded (rather than the square corners 38, 40 of the present invention) which may exhibit an undesired bending moment. The in-line force translation of the inventive C-Style plunger in turn reduces the stress on the connecting hardware compared to alternate designs and thereby increases the usable life of the plungers and connected shoes. Before machining, it is preferred that the part be normalized at 880° C. and that the part be machined and drilled in one setup. The part is to be deburred after machining and drilling, and is not typically to be painted.

Having described and illustrated the principles of the invention in a preferred embodiment thereof, it should be apparent that the invention can be modified in arrangement and detail without departing from such principles. Accordingly, we claim all modifications and variation coming within the spirit and scope of the following claims.

What is claimed is:

1. A head assembly for use on a concrete products forming machine (CPM) comprising:
a framework configured to be secured to a vertically displaceable compression beam on a CPM;
an array of shoes sized to be fully received within complimentary mold cavities within a mold box of the CPM; and
an array of plungers interposed between the framework and array of shoes, with at least a plurality of the plungers of the array secured at one end to the framework and at another end to a single one of the array of shoes,
wherein the plurality of plungers are configured with a C-shaped webbing comprised of upper and lower substantially parallel flange pieces connected via a structural upright forming an outside right-angle edge with each of the upper and lower flange pieces.

2. The head assembly of claim 1, wherein each of the shoes in the array include a plurality of associated plungers coupled thereto that are spaced from one another.

3. The head assembly of claim 2, wherein the plurality of associated plungers for each of the shoes includes a pair of plungers coupled in spaced relation to one another such that the C-shaped webbing of each of the plungers in the pair face inwards toward one another.

4. The head assembly of claim 1, wherein the structural upright of each of the plurality of plungers is thicker than the flange pieces.

5. The head assembly of claim 1, wherein the framework includes a plurality of grooves disposed in parallel on an underside thereof, with the array of plungers received within the grooves to mitigate twisting of the plungers with respect to the framework.

6. The head assembly of claim 1, wherein the upper flange pieces make full contact with the framework on first sides and the lower flange pieces make full contact with the shoes on second sides from terminal edges to the right angle edges of each of the flange pieces so that a moment of pressure is translated along the structural upright.

7. A plunger for use between a shoe and framework in a concrete products forming machine, the plunger comprising:
a C-shaped webbing comprised of upper and lower substantially parallel flange pieces connected via a structural upright forming an outside right-angle corner with each of the upper and lower flange pieces.

8. The plunger of claim 7, wherein the structural upright of each of the plurality of plungers is thicker than the flange pieces.

9. The plunger of claim 7, further including an inside-angle edge between the upper and lower flange pieces and the interposed structural upright defined by a first radius.

10. The plunger of claim 9, further wherein the inside-angle edge between the upper and lower flange pieces and the interposed structure upright is also defined by a second radius adjacent the first radius.

11. The plunger of claim 10, wherein the first radius is adjacent the flange pieces and the second radius, and the second radius is adjacent the structural upright and the first radius, and wherein the first radius is smaller than the second radius.

12. The plunger of claim 11, wherein the upper and lower flange pieces include a rolled edge on a distal section of the flange pieces of a third radius.

13. The plunger of claim 12, wherein the upper and lower flange pieces include a second rolled edge on the distal section of the flange pieces of a fourth radius, wherein the third and fourth radius are different from one another.

14. The plunger of claim 13, wherein the third radius is greater than the fourth radius.

15. The plunger of claim 7, wherein the flange pieces each include an aperture formed therethrough that are each configured to receive a fastener for fixing the plunger between the shoe and framework.

16. The plunger of claim 15, wherein the aperture through the upper flange is laterally offset relative to the lower flange so that fasteners receive within the apertures are parallel but not axial to one another.
